(19) United States
(12) Patent Application Publication
(10) Pub. No.: US 2025/0330709 A1
(43) Pub. Date: Oct. 23, 2025

(54) CAMERA MODULE

(71) Applicant: Samsung Electro-Mechanics Co., Ltd., Suwon-si (KR)

(72) Inventors: Deok Hyun LEE, Suwon-si (KR); Young Bok YOON, Suwon-si (KR); Ki Ho LEE, Suwon-si (KR); Jun Sup SHIN, Suwon-si (KR)

(73) Assignee: Samsung Electro-Mechanics Co., Ltd., Suwon-si (KR)

(21) Appl. No.: 19/010,853

(22) Filed: Jan. 6, 2025

(30) Foreign Application Priority Data
Apr. 19, 2024 (KR) 10-2024-0052438

(51) Int. Cl. H04N 23/68; G03B 5/02; G03B 30/00

(52) U.S. Cl. CPC H04N 23/687; G03B 5/02; G03B 30/00; G03B 2205/0038

(57) ABSTRACT

A camera module includes a lens module including at least one lens; a frame to which the lens module is coupled being movable in a direction perpendicular to an optical axis; a carrier in which the frame is accommodated; a plurality of magnets disposed on the frame, and a plurality of pulling yokes disposed on the carrier to face each of the plurality of magnets. Each of the plurality of pulling yokes includes a first direction extension portion extending in a longitudinal direction of the plurality of magnets, and a second direction extension portion extending in a thickness direction of the plurality of magnets.

### CROSS-REFERENCE TO RELATED APPLICATIONS

This application claims the benefit under 35 USC 119(a) of Korean Patent Application No. 10-2024-0052438 filed on Apr. 19, 2024, in the Korean Intellectual Property Office, the entire disclosure of which is incorporated herein by reference for all purposes.

### BACKGROUND

The following description relates to a camera module.

### 2. Description of the Background

High-performance camera modules that are similar in performance to conventional cameras are used in mobile devices such as smartphones.

For example, camera modules used in mobile devices basically have autofocus, shake correction functions, and zoom functions.

However, in the case of mobile devices, the space in which the camera module can be mounted becomes more limited as the thickness of mobile devices gradually decreases; thus, more slimmer camera modules are desired.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module including at least one lens; a frame to which the lens module is coupled being movable in a direction perpendicular to an optical axis; a carrier in which the frame is accommodated; a plurality of magnets disposed on the frame, and a plurality of pulling yokes disposed on the carrier to face each of the plurality of magnets. Each of the plurality of pulling yokes includes a first direction extension portion extending in a longitudinal direction of the plurality of magnets, and a second direction extension portion extending in a thickness direction of the plurality of magnets.

The plurality of magnets may include a first shake correction magnet and a second shake correction magnet disposed on different side surfaces of the frame perpendicular to each other. Either one or both of the first shake correction magnet and the second shake correction magnet may have a polarity region asymmetrically disposed with respect to a longitudinal direction.

The first shake correction magnet and the second shake correction magnet may include a first polarity region, a neutral region, and a second polarity region disposed along the longitudinal direction thereof. An area of the first polarity region may be equal to or larger than an area of the second polarity region.

The plurality of pulling yokes may include a first portion facing the first polarity region, and a second portion, spaced apart from the first portion, facing the second polarity region. A length of the first portion may be longer than a length of the second portion in the longitudinal direction of the plurality of magnets.

The first portion and the second portion may include the first direction extension portion and the second direction extension portion, respectively.

The second direction extension portion may be disposed at least on both ends of the plurality of pulling yokes in a longitudinal direction.

The camera module may further include a guide member disposed between the frame and the carrier to guide movement of the frame relative to the carrier. The plurality of pulling yokes may face the plurality of magnets in the optical axis direction with the guide member interposed therebetween.

The guide member may include a plurality of ball members capable of rolling in either one or both of a first axis direction perpendicular to the optical axis and a second axis direction perpendicular to both the optical axis and the first axis.

A first shake correction coil and a second shake correction coil may be disposed to face the first shake correction magnet and the second shake correction magnet in a direction perpendicular to the optical axis, respectively. The first shake correction coil and the second shake correction coil may include a plurality of coils facing the first polarity region and the second polarity region, respectively.

The coil facing the first polarity region may have a longer length than the coil facing the second polarity region.

The camera module may further include position sensors disposed to face the first polarity region of the first shake correction magnet and the second shake correction magnet, respectively.

The position sensors may be disposed in a number corresponding to the number of the shake correction magnets.

In another general aspect, a camera module includes a lens module including at least one lens; a frame which the lens module is coupled being movable in a direction perpendicular to the optical axis; a carrier in which the above frame is accommodated; and a plurality of magnets disposed on the frame, and a plurality of pulling yokes spaced apart in a longitudinal direction of the plurality of magnets disposed on the carrier. The plurality of magnets includes a first polarity region and a second polarity region having different areas along the longitudinal direction thereof.

The plurality of pulling yokes may include a first portion facing the first polarity region, and a second portion spaced apart from the first polarity region and facing the second polarity region. The first portion may have a longer length than the second portion in the longitudinal direction of the plurality of magnets.

The plurality of pulling yokes may include a first direction extension portion extending in the longitudinal direction of the plurality of magnets, and a second direction extension portion extending in a thickness direction of the plurality of magnets.

The plurality of pulling yokes may include the second direction extension portion at least on both ends of a longitudinal direction of the plurality of pulling yokes.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of a camera module according to an embodiment of the present disclosure.

FIG. 3 is an exploded perspective view of a focus adjustment portion according to an embodiment of the present disclosure.

FIG. 4 is an exploded perspective view of a shake correction portion according to an embodiment of the present disclosure.

FIG. 5 is a perspective view of a shake correction driving portion according to an embodiment of the present disclosure.

FIG. 6 is a plan view of a shake correction driving portion according to an embodiment of the present disclosure.

FIG. 7A is a cross-sectional view taken along line I-I′ of FIG. 1.

FIG. 7B is a cross-sectional view taken along line II-II′ of FIG. 1.

FIG. 8 illustrates a pulling yoke according to an embodiment of the present disclosure.

FIG. 9 illustrates an arrangement relationship between a shake correction magnet and a pulling yoke according to an embodiment of the present disclosure.

FIG. 10A and FIG. 10B are conceptual diagrams for explaining the restoring force of a pulling yoke according to an embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

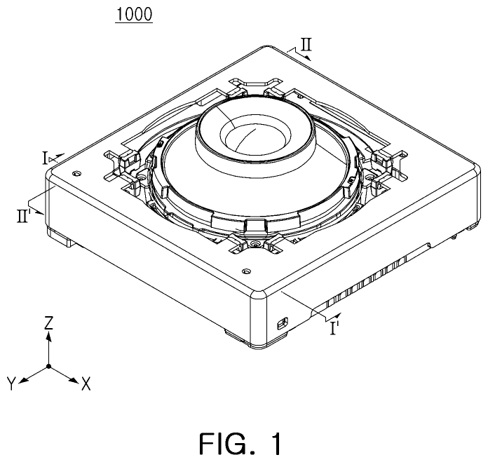

FIG. 1 is a perspective view of a camera module according to an embodiment of the present disclosure.

The camera module (1000), according to an embodiment of the present disclosure, may be adopted in a mobile device. For example, a mobile device may be a portable electronic device such as a smartphone, a tablet PC, etc.

The camera module (1000) may be mounted on a mobile device such that the Z-axis direction (hereinafter, optical axis direction) based on the drawing corresponds to a thickness direction of the mobile device.

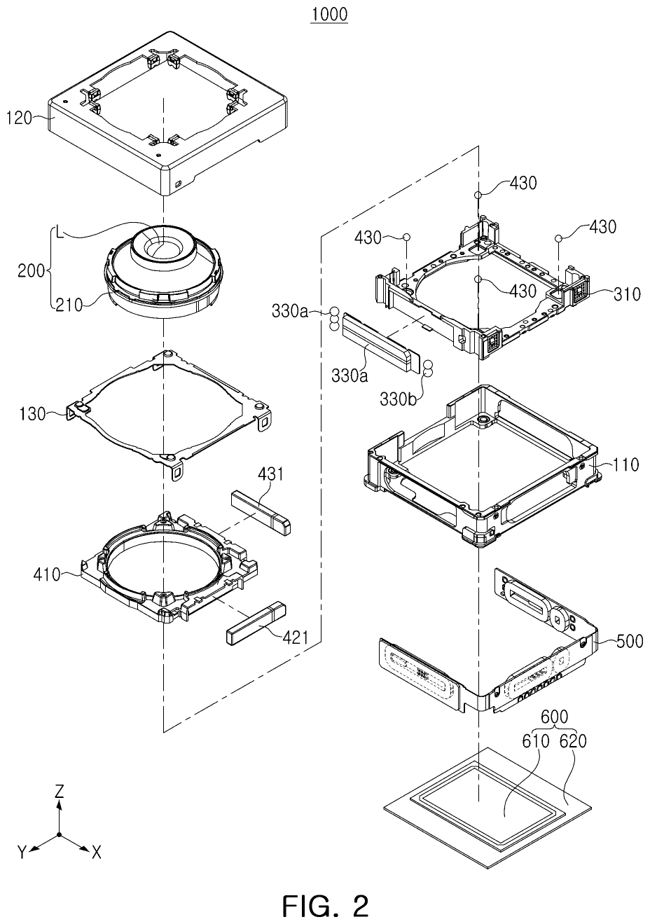

FIG. 2 is an exploded perspective view of a camera module according to an embodiment of the present disclosure.

Referring to FIG. 2, the camera module (1000) may include a lens module (200), a lens driving device, an image sensor module (600), a housing (110) and a case (120) accommodating the lens module (200), etc.

The lens module (200) may include a lens barrel (210) with a hollow cylindrical shape and a plurality of lenses (L) mounted on the lens barrel (210).

A plurality of lenses (L) may be mounted inside the lens barrel (210) along an optical axis direction (Z-axis direction). A plurality of lenses (L) may be provided in a desired number and may have the same or different optical characteristics.

The lens driving device may move the lens module (200). In an embodiment, the lens driving device may include a focus adjustment portion (300) moving the lens module (200) in the optical axis direction (Z-axis direction) and a shake correction portion (400) moving the lens module (200) in a direction, perpendicular to the optical axis (X-axis and Y-axis directions).

The image sensor module (600) may include an image sensor (610) and a printed circuit board (hereinafter, sensor substrate) (620) on which the image sensor (610) may be mounted.

The image sensor (610) may be electrically connected to the sensor substrate (620) through wire bonding or the like.

The image sensor (610) may convert light incident on the lens module (200) into an electric signal. For example, the image sensor (610) may be a CCD (Charged Coupled Device) or a CMOS (Complementary Metal-Oxide Semiconductor).

The electrical signal converted by the image sensor (610) may be output as an image or video through a display unit of the mobile device.

Although not illustrated in the drawing, the image sensor module (600) may further include a filter section disposed upper side of the image sensor (610). For example, the filter portion may be an infrared blocking filter blocking infrared light from among the light incident on the image sensor (610).

The housing (110) may be a fixed body forming an exterior of the camera module (1000). For example, the housing (110) may be a square box shape with an internal space.

A portion of the lens module (200) and the lens driving device may be movably accommodated in the internal space of the housing (110). That is, the portion of the lens module (200) and the lens driving device may be movable.

Meanwhile, the image sensor module (600) and the remaining portion of the lens driving device may be fixedly coupled to the housing (110).

The case (120) may be coupled to the housing (110) to cover the internal space. The case (120) may serve to protect the components accommodated in the internal space of the housing (110).

The case (120) may also serve to shield electromagnetic waves. To this end, the case (120) may be provided with a metal material and may be grounded to a ground pad provided on the sensor substrate (620).

Additionally, the camera module (1000) may include a stopper (130).

The stopper (130) may limit a range of movement in the optical axis direction (Z-axis direction) and prevent the components from being detached due to external impacts, etc. This will be described in detail later.

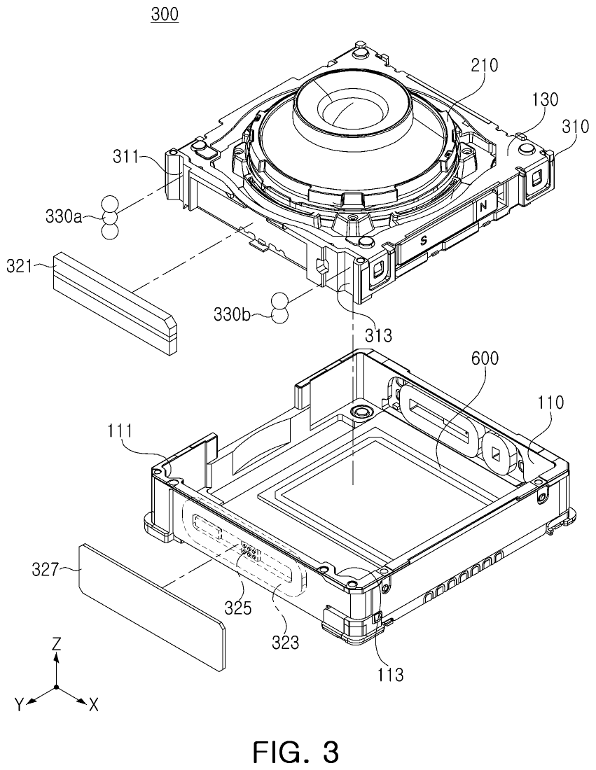

FIG. 3 is an exploded perspective view of a focus adjustment portion according to an embodiment of the present disclosure.

The focus adjustment portion (300) may move the lens module (200) in the optical axis direction (Z-axis direction) to focus on a subject.

The focus adjustment portion (300) may include a carrier (310) accommodating a lens module (200), and a focus adjustment driving portion (hereinafter, a first driving portion) generating driving force to move the lens module (200) and the carrier (310) along the optical axis (Z-axis direction).

The first driving portion may be a voice coil motor (VCM), which includes a first driving magnet (321) and a first driving coil (323).

The first driving magnet (321) may be disposed on the carrier (310). For example, the first driving magnet (321) may be disposed on one side surface of the carrier (310).

The first driving coil (323) may be disposed in the housing (110). For example, the first driving coil (323) may be disposed on one side surface of the housing (110) via a printed circuit board (hereinafter, main board) (500).

The first driving magnet (321) and the first driving coil (323) may face each other in a direction, perpendicular to the optical axis (Z-axis).

The first driving magnet (321) and the first driving coil (323) may generate driving force in a direction, perpendicular to the direction in which they face each other. For example, when power is applied to the first driving coil (323), the first driving magnet (321) and the first driving coil (323) may generate driving force in the optical axis direction (Z-axis direction). Accordingly, the carrier (310) may move forward and backward in the optical axis direction (Z-axis direction).

The lens module (200) accommodated in the carrier (310) may move in the optical axis direction (Z-axis direction) together with the carrier (310).

The movement of the carrier (310) and the lens module (200) in the optical axis direction (Z-axis direction) may be relative movement with respect to the housing (110).

A guide member (330a, 330b) may be disposed between the carrier (310) and the housing (110).

The guide member (330a, 330b) guides the movement of the carrier (310) in the optical axis direction (Z-axis direction) and may reduce friction between the carrier (310) and the housing (110) when the carrier (310) moves in the optical axis direction (Z-axis direction). For example, the guide member (330a, 330b) may be in a shape of a ball (sphere).

The guide members (330a, 330b) may be spaced apart in the length direction of the first driving magnet (321) with the first driving magnet (321) interposed therebetween.

A first guide member (330a) may be disposed on one longitudinal side of the first driving magnet (321), and a second guide member (330b) may be disposed on the other longitudinal side of the first driving magnet (321).

The first guide member (330a) and the second guide member (330b) may include a plurality of balls disposed in the optical axis direction (Z-axis direction).

In an embodiment, the first guide member (330a) may include a greater number of balls than the second guide member (330b). In this case, the first guide member (330a) may be the main guide, and the second guide member (330b) may be the auxiliary guide.

The first guide member (330a) and the second guide member (330b) may roll in the optical axis direction (Z-axis direction) when the first driving portion generates a driving force.

The first guide member (330a) and the second guide member (330b) may be accommodated between guide grooves (311, 313, 111, 113) provided in the carrier (310) and the housing (110), respectively, and may roll in the optical axis direction (Z-axis direction).

The guide groove (311, 313, 111, 113) may be in a form extending in the optical axis direction (Z-axis direction) along which the first guide member (330a) and the second guide member (330b) are rolling.

The carrier (310) may include a first guide groove (311) provided on one side in the longitudinal direction of the first driving magnet (321). The housing (110) may include a second guide groove (111) facing the first guide groove (311) in a direction perpendicular to the optical axis (Z-axis).

A first guide member (330a) may be accommodated between the first guide groove (311) and the second guide groove (111).

In an embodiment, a plurality of balls included in the first guide member (330a) may each make two-point contact with the first guide groove (311) and the second guide groove (111).

The carrier (310) may include a third guide groove (313) provided on the other longitudinal side of the first driving magnet (321). The housing (110) may include a fourth guide groove (113) facing the third guide groove (313) in a direction perpendicular to the optical axis (Z-axis).

A second guide member (330b) may be accommodated between the third guide groove (313) and the fourth guide groove (113).

In an embodiment, a plurality of balls included in the second guide member (330b) may each make two-point contact with one of the third guide grooves (313) and the fourth guide groove (113) and one-point contact with the other.

A first yoke (327) may be disposed on one side surface of the housing (110). For example, the first yoke (327) may be disposed facing the first driving magnet (321) with the first driving coil (323) interposed therebetween.

The first yoke (327) may be provided with a magnetic body. Accordingly, the first yoke (327) may generate a force with the first driving magnet (321).

In detail, attractive force may be applied between the first yoke (327) and the first driving magnet (321) in a direction facing each other, that is, in a direction perpendicular to the optical axis (Z-axis).

Accordingly, the carrier (310) may be supported in close contact with the housing (110) in a direction perpendicular to the optical axis (Z-axis), and contact between them and the guide members (330a, 330b) disposed therebetween may be maintained.

In addition, the first yoke (327) forms a magnetic circuit with the first driving magnet (321), thereby focusing the magnetic force generated from the first driving magnet (321).

In an embodiment, an optical axis direction (Z-axis direction) length (L1a) of the first yoke (327) may be longer than an optical axis direction (Z-axis direction) length (L1b) of the first driving magnet (321).

If the optical axis direction (Z-axis direction) length (L1a) of the first yoke (327) is shorter than the optical axis direction (Z-axis direction) length (L1b) of the first driving magnet (321), when the carrier (310) may be moved in the optical axis direction (Z-axis direction), a strong return force may be applied to the first driving magnet (321) to return to an original position, that is, a position where a center of the first driving magnet (321) faces a center of the first yoke (327). This causes an increase in the power consumption desired for movement in the optical axis direction (Z-axis direction).

However, as in an embodiment, if the optical axis direction (Z-axis direction) length (L1a) of the first yoke (327) is longer than the optical axis direction (Z-axis direction) length (L1b) of the first driving magnet (321), when the carrier (310) may be moved in the optical axis direction (Z-axis direction), the return force for the first driving magnet (321) to return to its original position becomes relatively weak, so that the power consumption desired for movement in the optical axis direction (Z-axis direction) may be reduced.

The camera module (1000) may use a closed loop control method to detect and provide feedback on the optical axis direction (Z-axis direction) position of the lens module (200).

For this purpose, a first position sensor (325) may be disposed on the main board (500) to face the first driving magnet (321). For example, the first position sensor (325) may be a Hall sensor.

In addition, the main board (500) may be equipped with a circuit element providing a driving signal to the focus adjustment portion (300). For example, the circuit element may be provided as a separate component or may be formed integrally with the first position sensor (325).

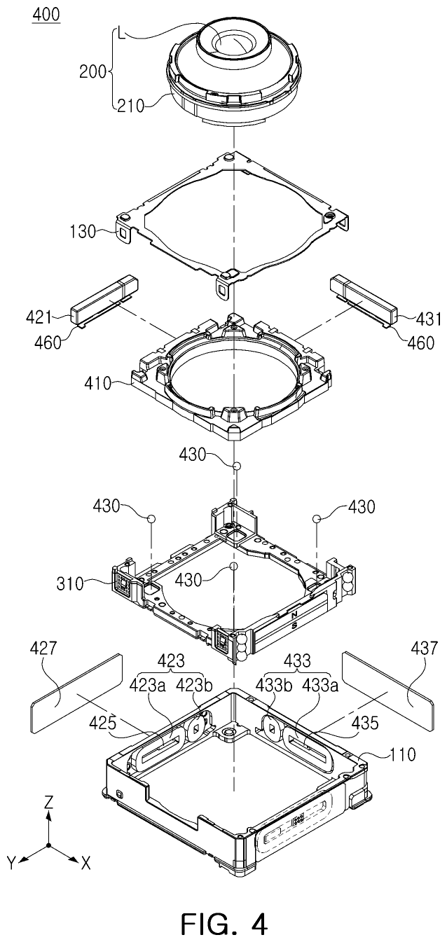

FIG. 4 is an exploded perspective view of a shake correction portion according to an embodiment of the present disclosure.

The shake correction portion (400) may provide relative displacement corresponding to shake to the lens module (200) in order to correct image blurring or video shaking due to external factors, such as a user's hand-shake, during imaging. For example, the shake correction portion (400) may move the lens module (200) in a direction perpendicular to the optical axis (Z-axis) (X-axis and Y-axis directions).

The shake correction portion (400) may include a frame (410) in which the lens module (200) is disposed, and a shake correction driving portion (hereinafter, the second driving portion and the third driving portion) generating driving force to move the lens module (200) and the frame (410) in a direction perpendicular to the optical axis (Z-axis) (X-axis and Y-axis directions). For example, the second driving portion may generate driving force to move the lens module (200) and the frame (410) in a first axis direction (X-axis) perpendicular to the optical axis (Z-axis), and the third driving portion may generate driving force to move the lens module (200) and the frame (410) in a second axis direction (Y-axis direction), perpendicular to the optical axis (Z-axis) and the first axis (X-axis).

The frame (410) may be accommodated in the carrier (310) while combined with the lens module (200).

Meanwhile, the stopper (130) may be combined with the carrier (310) to cover the upper portion of the frame (410).

The frame (410) may not be separated from the carrier (310) even if an external impact occurs due to the stopper (130).

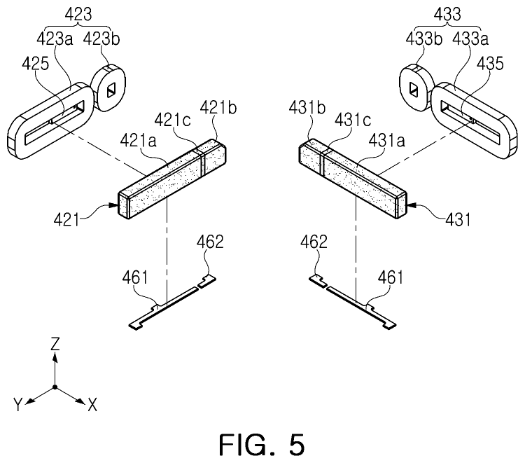

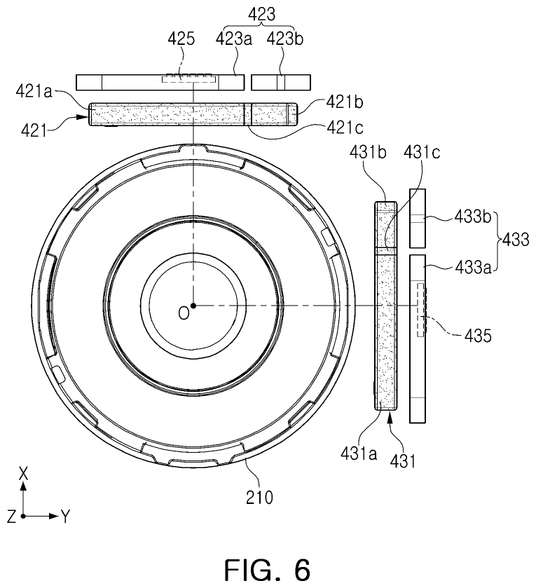

FIG. 5 is a perspective view of a shake correction driving portion according to an embodiment of the present disclosure, and FIG. 6 is a plan view of a shake correction driving portion according to an embodiment of the present disclosure.

The second driving portion may be a voice coil motor (VCM), including a second driving magnet (or a first shake correction magnet) (421) and a second driving coil (or a first shake correction coil) (423). In addition, the third driving portion may be a voice coil motor (VCM), including a third driving magnet (or a second shake correction magnet) (431) and a third driving coil (or a second shake correction coil) (433).

The second driving magnet (421) and the third driving magnet (431) may be disposed on the frame (410). For example, the second driving magnet (421) and the third driving magnet (431) may be disposed on two mutually perpendicular side surfaces of the frame (410).

The second driving coil (423) and the third driving coil (433) may be disposed in the housing (110). For example, the second driving coil (423) and the third driving coil (433) may be disposed on two mutually perpendicular side surfaces of the housing (110) via the main board (500).

The second driving magnet (421) and the second driving coil (423) may face each other in the first axis direction (X-axis direction), perpendicular to the optical axis (Z-axis).

The second driving magnet (421) and the second driving coil (423) may generate driving force in an opposing direction. For example, when power is applied to the second driving coil (423), the second driving magnet (421) and the second driving coil (423) may generate driving force in the first axis direction (X-axis direction). Accordingly, the frame (410) may move forward and backward in the first axis direction (X-axis direction).

The third driving magnet (431) and the third driving coil (433) may face each other in the second axis direction (Y-axis direction) that is perpendicular to both the optical axis (Z-axis) and the first axis (X-axis).

The third driving magnet (431) and the third driving coil (433) may also generate driving force in an opposing direction. For example, when power is applied to the third driving coil (433), the third driving magnet (431) and the third driving coil (433) may generate driving force in the second-axis direction (Y-axis direction). Accordingly, the frame (410) may move forward and backward in the second-axis direction (Y-axis direction).

The lens module (200) coupled to the frame (410) may move in the first axis direction (X-axis direction) and the second axis direction (Y-axis direction) together with the frame (410).

The first-axis direction (X-axis direction) and second-axis direction (Y-axis direction) movement of the frame (410) and the lens module (200) may be relative movement with respect to the carrier (310).

The second driving magnet (421) may include a first polarity region (421a) and a second polarity region (421b) provided along a longitudinal direction of the second driving magnet (421). For example, the first polarity region (421a) may be an N pole (or S pole), and the second polarity region (421b) may be an S pole (or N pole). A neutral region (421c) may be provided between the first polarity region (421a) and the second polarity region (421b).

The third driving magnet (431) may also be provided with a first polarity region (431a), a neutral region (431c), and a second polarity region (431b) along a longitudinal direction of the third driving magnet (431).

In an embodiment, the second driving magnet (421) and the third driving magnet (431) may have asymmetrically disposed polarity regions.

Specifically, the area or lengths of the first polarity region (421a, 431a) and the area or length of the second polarity region (421b, 431b) may differ.

For example, the first polarity region (421a, 431a) may have a larger area or longer length than the second polarity region (421b, 431b). Accordingly, the neutral region (421c, 431c) may be positioned offset from the optical axis (Z-axis), i.e., the center of the lens.

Meanwhile, referring to FIG. 5, the second driving magnet (421) and the third driving magnet (431) may be disposed symmetrically with respect to an imaginary line passing between the second driving magnet (421) and the third driving magnet (431) while dividing the first axis (X-axis) and the second axis (Y-axis) in half. For example, the second driving magnet (421) and the third driving magnet (431) may be disposed so that the second polarity regions (421b, 431b) may be adjacent to the imaginary line.

The second drive coil (423) may include a first coil (423a) facing the first polarity region (421a) of the second driving magnet (421) and a second coil (423b) facing the second polarity region (421b). Similarly, the third drive coil (433) may include a third coil (433a) facing the first polarity region (431a) of the third driving magnet (431) and a fourth coil (433b) facing the second polarity region (431b).

In an embodiment, the first coil (423a) and the third coil (433a) facing the first polarity region (421a, 431a) may have different lengths from the second coil (423b) and the fourth coil (433b) facing the second polarity region (421b, 431b).

For example, the first coil (423a) and the third coil (433a) may have lengths corresponding to the first polarity region (421a, 431a). The second coil (423b) and the fourth coil (433b) may have lengths corresponding to the second polarity region (421b, 431b). Therefore, the first coil (423a) and the third coil (433a) may have longer lengths than the second coil (423b) and the fourth coil (433b).

A third guide member (430) may be disposed between the frame (410) and the carrier (310). For example, the third guide member (430) may be disposed between the surfaces of the frame (410) and the carrier (310) facing each other in the optical axis direction (Z-axis direction).

The third guide member (430) may guide a movement of the frame (410) in the first axis direction (X-axis direction) and the second axis direction (Y-axis direction). In addition, it may maintain a gap between the frame (410) and the carrier (310). For example, the third guide member (430) may be shaped like a ball (sphere).

The third guide member (430) may include three or more balls. For example, the third guide member (430) may include four balls disposed at each corner portion of the frame (410) and the carrier (310).

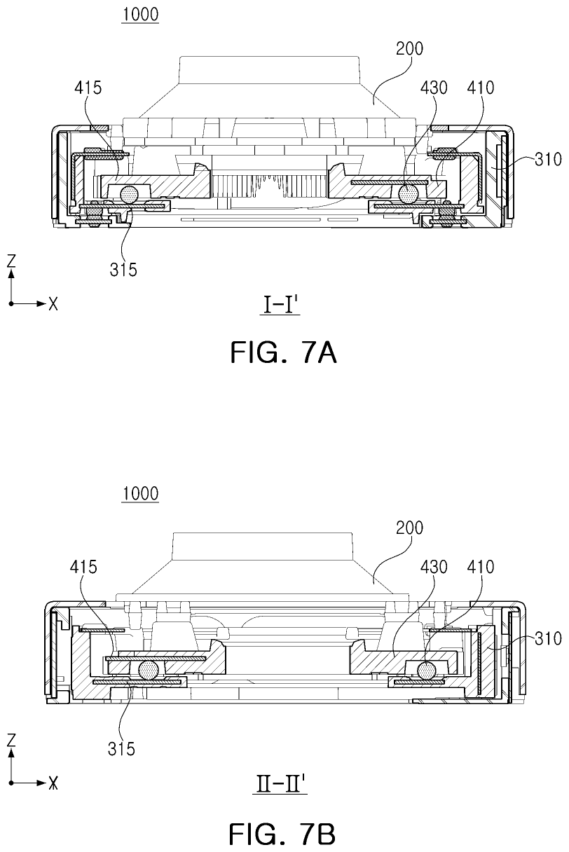

FIG. 7A is a cross-sectional view taken along line I-I′ of FIG. 1. FIG. 7B is a cross-sectional view taken along line II-II′ of FIG. 1.

In an embodiment, a rolling direction of the third guide member (430) is not restricted to a specific direction and may roll in the first axis direction (X-axis direction) and the second axis direction (Y-axis direction). For example, the third guide member (430) may roll in the first axis direction (X-axis direction) when the second driving portion generates the driving force and may roll in the second axis direction (Y-axis direction) when the third driving portion generates the driving force.

The third guide member (430) may be accommodated between guide grooves (415, 315) provided in the frame (410) and the housing (310), respectively, and may roll in the first axis direction (X-axis direction) and the second axis direction (Y-axis direction).

The frame (410) may include a fifth guide groove (415) on a surface facing the carrier (310) in the optical axis direction (Z-axis direction). The carrier (310) may include a sixth guide groove (315) facing the fifth guide groove (415) in the optical axis direction (Z-axis direction).

A third guide member (430) may be accommodated between the fifth guide groove (415) and the sixth guide groove (315).

In an embodiment, a plurality of balls included in the third guide member (430) may each come into one-point contact with the fifth guide groove (415) and the sixth guide groove (315). For example, the fifth guide groove (415) and the sixth guide groove (315) may have a flat surface contacting a plurality of balls when viewed in the first-axis direction (X-axis direction) and the second-axis direction (Y-axis direction). In addition, the fifth guide groove (415) and the sixth guide groove (315) may have a length longer than the diameter of the plurality of balls in the first-axis direction (X-axis direction) and the second-axis direction (Y-axis direction).

Therefore, the third guide member (430) may freely move in the first axis direction (X-axis direction) and the second axis direction (Y-axis direction). Furthermore, the third guide member (430) may freely roll on a plane surface (XY plane) perpendicular to the optical axis (Z-axis).

In this way, in a case where the third guide member (430) may have a structure capable of rolling in the first axis direction (X-axis direction) and the second axis direction (Y-axis direction), there may be an advantage in that the thickness of the camera module (1000) in the optical axis direction (Z-axis direction) may be reduced.

Meanwhile, in a structure in which the third guide member (430) may move in both the first axis direction (X-axis direction) and the second axis direction (Y-axis direction) as in an embodiment of the present disclosure, the lens module (200) may rotate about the optical axis (Z-axis) due to the unintended application of unequal force during a process in which the second driving portion and the third driving portion generate driving force.

In this way, unintended rotational force applied to the lens module (200) may be offset by the pulling yoke (460) disposed on the carrier (310).

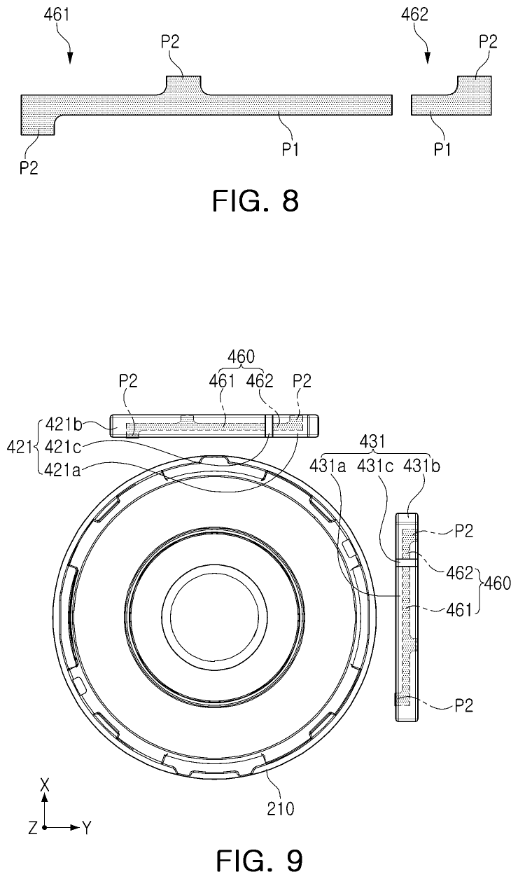

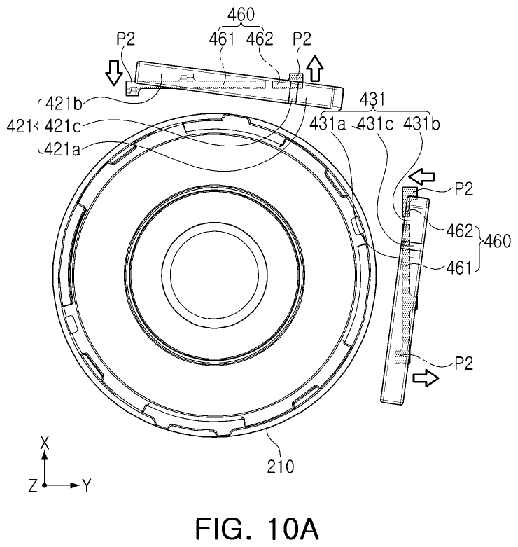

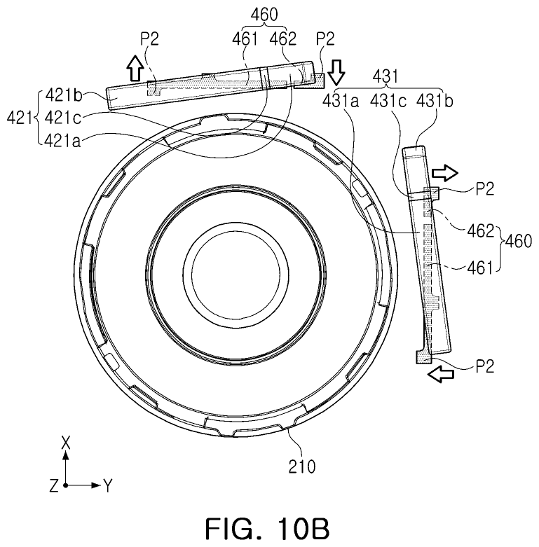

FIG. 8 illustrates a pulling yoke according to an embodiment of the present disclosure. FIG. 9 illustrates an arrangement relationship between a shake correction magnet and a pulling yoke according to an embodiment of the present disclosure. FIG. 10A and FIG. 10B are conceptual diagrams for explaining a restoring force of a pulling yoke according to an embodiment of the present disclosure.

The pulling yoke (460) may be disposed on a surface facing the frame (410) in the optical axis direction (Z-axis direction) of the carrier (310).

In an embodiment, the pulling yoke (460) may be insert-molded into the carrier (310). However, the pulling yoke (460) may be manufactured separately from the carrier (310) and then attached to the carrier (310).

The pulling yoke (460) may be disposed facing the second driving magnet (421) and the third driving magnet (431).

The pulling yoke (460) may be provided with a magnetic body. Accordingly, the pulling yoke (460) may generate attractive force with the second driving magnet (421) and the third driving magnet (431).

In detail, attractive force may be applied between the pulling yoke (460) and the second driving magnet (421) and the third driving magnet (431) in a direction in which they face each other, that is, in the direction of the optical axis (Z-axis direction).

Accordingly, the frame (410) may be closely supported on the carrier (310) in the optical axis direction (Z-axis direction), and contact between them and the third guide member (430) disposed between them may be maintained.

The pulling yoke (460) may offset unintended rotational force applied to the lens module (200) as described above.

In an embodiment, the pulling yoke (460) may include a first portion (461) facing the first polarity regions (421a, 431a) of the second driving magnet (421) and the third driving magnet (431), and a second portion (462) facing the second polarity regions (421b, 431b).

The first portion (461) and the second portion (462) may be spaced apart from each other. For example, the first portion (461) and the second portion (462) may be spaced apart from each other based on the neutral region (421c, 431c).

In an embodiment, the first portion (461) facing the first polarity region (421a, 431a) and the second portion (462) facing the second polarity region (421b, 431b) may have different lengths. For example, the first portion (461) may be longer than the second portion (462).

The pulling yoke (460) may be extended in a direction parallel to the longitudinal direction of the second driving magnet (421) and the third driving magnet (431).

In detail, the first part (461) and the second part (462) may be extended in a direction (hereinafter, the first direction) parallel to the longitudinal direction of the second driving magnet (421) and the third driving magnet (431) as a whole.

The pulling yoke (460) may include a portion extending in a direction parallel to a thickness direction of the second driving magnet (421) and the third driving magnet (431) to offset a rotational force generated in the lens module (200).

In detail, the first part (461) and the second part (462) may be formed to extend in the thickness direction (hereinafter, the second direction) of the second driving magnet (421) and the third driving magnet (431) in some cases. The first part (461) and the second part (462) may include a second direction extension portion (P2) extending in the second direction.

In an embodiment, the longitudinal ends of the pulling yoke (460) may be second direction extensions (P2). In the longitudinal ends of the pulling yoke (460), one end may be a part of the first part (461), and the other end may be a part of the second part (462). These may roughly face the longitudinal ends of the second driving magnet (421) and the third driving magnet (431) in the optical axis direction (Z-axis direction).

In addition, a middle portion of the pulling yoke (460) may also be a second direction extension (P2). This may be a portion of the first portion (461) and may face approximately the middle point of the length direction of the second driving magnet (421) and the third driving magnet (431) in the optical axis direction (Z-axis direction).

The attractive force between the pulling yoke (460) and the second driving magnet (421) and the third driving magnet (431) may act toward a longitudinal center of the pulling yoke (460). Therefore, when the pulling yoke (460) includes only the first direction extension portion (P1), there may be a limit to offsetting the rotational force applied to the lens module (200).

However, as in an embodiment of the present disclosure, when the pulling yoke (460) includes second direction extensions (P2) at both ends, the attractive forces are applied in opposite directions at both ends in the longitudinal direction of the second driving magnet (421) and the third driving magnet (431), so that the rotational force applied to the lens module (200) may be offset.

That is, the second direction extension portion (P2) may be disposed to overlap the longitudinal end portions of the second driving magnet (421) and the third driving magnet (431) that are first misaligned with the pulling yoke (460) in the optical axis direction (Z-axis direction) when the lens module (200) may be rotated, and since a strong restoring force may be applied to a corresponding portion when the lens module (200) may be rotated, the rotation of the lens module (200) may be effectively offset.

The camera module (1000) may use a closed loop control method detecting and providing feedback on the positions of the lens module (200) in the first axis direction (X-axis direction) and the second axis direction (Y-axis direction).

To this end, the second position sensor (425) may be disposed on the main board (500) to face the second driving magnet (421), and the third position sensor (435) may be disposed to face the third driving magnet (431). For example, the second position sensor (425) and the third position sensor (435) may be Hall sensors.

In an embodiment, the second position sensor (425) may be disposed on the inner side of the first coil (423a) facing the first polarity region (421a) of the second driving magnet (421) among the second driving coils (423). In addition, the third position sensor (435) may be disposed on the inner side of the third coil (433a) facing the first polarity region (431a) of the third driving magnet (431) among the third driving coils (433).

In an embodiment, a virtual line extending in the first axis direction (X-axis direction) while passing through the optical axis (Z-axis) may pass through the second position sensor (425), and a virtual line extending in the second axis direction (Y-axis direction) while passing through the optical axis (Z-axis) may pass through the third position sensor (435).

Accordingly, a center of the second position sensor (425) and a center of the third position sensor (435) may roughly coincide with the optical axis (Z-axis), i.e., a center of the lens, and may be effective in precisely detecting the position of the lens module (200). By detecting the rotation of the lens module (200), the shake correction may be precisely controlled.

The main board (500) may be equipped with a circuit element providing a driving signal to the shake correction portion (400). For example, the circuit element may be provided in two pieces, each of which may provide a driving signal to the second or third driving portion. In addition, the circuit element may also be provided as a separate component or formed integrally with the second position sensor (425) and the third position sensor (435).

In an embodiment, the same driving signal may be input to the first coil (423a) and the second coil (423b) included in the second driving coil (423), and the same driving signal may be input to the third coil (433a) and the fourth coil (433b) included in the third driving coil (433).

A second yoke (427) and a third yoke (437) may be disposed on two mutually perpendicular sides of the housing (110). For example, the second yoke (427) may face the second driving magnet (421) with the second driving coil (423) interposed therebetween, and the third yoke (437) may face the third driving magnet (431) with the third driving coil (433) interposed therebetween.

The second yoke (427) and the third yoke (437) may focus a magnetic force generated from the second driving magnet (421) and the third driving magnet (431) to prevent leakage of a magnetic field.

One or more aspects of the present disclosure is to provide a camera module having an anti-rotation function.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens module comprising at least one lens;
a frame to which the lens module is coupled being movable in a direction perpendicular to an optical axis;
a carrier in which the frame is accommodated; and
a plurality of magnets disposed on the frame, and a plurality of pulling yokes disposed on the carrier to face each of the plurality of magnets,
wherein each of the plurality of pulling yokes comprises a first direction extension portion extending in a longitudinal direction of the plurality of magnets, and a second direction extension portion extending in a thickness direction of the plurality of magnets.

2. The camera module of claim 1, wherein the plurality of magnets comprises a first shake correction magnet and a second shake correction magnet disposed on different side surfaces of the frame perpendicular to each other, and
wherein either one or both of the first shake correction magnet and the second shake correction magnet have a polarity region asymmetrically disposed with respect to a longitudinal direction.

3. The camera module of claim 2, wherein the first shake correction magnet and the second shake correction magnet comprise a first polarity region, a neutral region, and a second polarity region disposed along the longitudinal direction thereof, and
wherein an area of the first polarity region is equal to or larger than an area of the second polarity region.

4. The camera module of claim 3, wherein the plurality of pulling yokes comprises a first portion facing the first polarity region, and a second portion, spaced apart from the first portion, facing the second polarity region, and
wherein a length of the first portion is longer than a length of the second portion in the longitudinal direction of the plurality of magnets.

5. The camera module of claim 4, wherein the first portion and the second portion comprise the first direction extension portion and the second direction extension portion, respectively.

6. The camera module of claim 1, wherein the second direction extension portion is disposed at least on both ends of the plurality of pulling yokes in a longitudinal direction.

7. The camera module of claim 1, further comprising a guide member disposed between the frame and the carrier to guide movement of the frame relative to the carrier,
wherein the plurality of pulling yokes face the plurality of magnets in the optical axis direction with the guide member interposed therebetween.

8. The camera module of claim 7, wherein the guide member comprises a plurality of ball members capable of rolling in either one or both of a first axis direction perpendicular to the optical axis and a second axis direction perpendicular to both the optical axis and the first axis.

9. The camera module of claim 3, wherein a first shake correction coil and a second shake correction coil is disposed to face the first shake correction magnet and the second shake correction magnet in a direction perpendicular to the optical axis, respectively, and
wherein the first shake correction coil and the second shake correction coil comprise a plurality of coils facing the first polarity region and the second polarity region, respectively.

10. The camera module of claim 9, wherein the coil facing the first polarity region has a longer length than the coil facing the second polarity region.

11. The camera module of claim 9, further comprising position sensors disposed to face the first polarity region of the first shake correction magnet and the second shake correction magnet, respectively.

12. The camera module of claim 11, wherein the position sensors are disposed in a number corresponding to the number of the shake correction magnets.

13. A camera module comprising:
a lens module comprising at least one lens;
a frame which the lens module is coupled being movable in a direction perpendicular to the optical axis;
a carrier in which the above frame is accommodated; and
a plurality of magnets disposed on the frame, and a plurality of pulling yokes spaced apart in a longitudinal direction of the plurality of magnets disposed on the carrier,
wherein the plurality of magnets comprises a first polarity region and a second polarity region having different areas along the longitudinal direction thereof.

14. The camera module of claim 13, wherein the plurality of pulling yokes comprises a first portion facing the first polarity region, and a second portion spaced apart from the first polarity region and facing the second polarity region, and
wherein the first portion has a longer length than the second portion in the longitudinal direction of the plurality of magnets.

15. The camera module of claim 14, wherein the plurality of pulling yokes comprises
a first direction extension portion extending in the longitudinal direction of the plurality of magnets, and
a second direction extension portion extending in a thickness direction of the plurality of magnets.

16. The camera module of claim 15, wherein the plurality of pulling yokes comprises the second direction extension portion at least on both ends of a longitudinal direction of the plurality of pulling yokes.
